(19) United States
(12) Patent Application Publication
(10) Pub. No.: US 2016/0045052 A1
(43) Pub. Date: Feb. 18, 2016

(54) HIGH EFFICIENCY HYBRID ECO-FRIENDLY COOKING CONTAINER

(71) Applicant: Bold Innovation Group Ltd., San Francisco, CA (US)

(72) Inventor: Jihyung Yu, Paju City (KR)

(21) Appl. No.: 14/660,138

(22) Filed: Mar. 17, 2015

(30) Foreign Application Priority Data
Mar. 18, 2014 (KR) 10-2014-0031555

(51) Int. Cl. A47J 27/00; A47J 36/06

(52) U.S. Cl. CPC A47J 27/002; A47J 36/06

(57) ABSTRACT

Disclosed is a high efficient hybrid eco-friendly cooking container, including: a container main body configured to contain a cooked material; and a lid body configured to seal an opened upper part of the container main body, in which the container main body has a dual structure, which includes a container inner skin and a container outer skin, and in which an air chamber empty while maintaining a predetermined interval is formed between the container inner skin and the container outer skin, a plurality of exhaust holes communicated with the air chamber is formed in a circumference of an upper end part of the container outer skin, an upper end of the container inner skin and an upper end of the container outer skin are connected with a connection body, and a circumference of the upper end of the container inner skin is bent in an outer direction to form a latching jaw part and be integrated with the connection body, and an assembling recess shaped like a half-circle is formed on a lower surface of the connection body with an interval corresponding to the latching jaw part and in this state, the upper end of the container outer skin is fitted into the assembling recess, and a flow hole is formed in the latching jaw part. Accordingly, at least 40% of total heat energy consumed while heating a cooking container is utilized for cooking, so that it is possible to improve cooking efficiency, efficiently remove condensate water generated while cooking, and burn even odor molecules and minimize generation of smell.

### CROSS-REFERENCE TO RELATED APPLICATIONS

This application claims priority to and the benefit of Korean Patent Application No. 10-2014-0031555 filed in the Korean Intellectual Property Office on Mar. 18, 2014, the entire contents of which are incorporated herein by reference.

### TECHNICAL FIELD

The present invention relates to a high efficient hybrid eco-friendly cooking container, and more particularly, to a new conceptual and high efficient hybrid eco-friendly cooking container, which is capable of decreasing a cooking time by maximizing thermal transfer efficiency, evenly heating an entire container and effectively discharging and removing condensate water generated inside a lid while cooing to improve cooking quality, and considerably reducing generation of smell.

### BACKGROUND ART

In general, a cooking container using fire as a heat source has a low efficient structure, in which only the minimum heat energy is directly used in cooking, and most of the remaining heat energy is discharged to the air.

That is, most of the currently used cooking containers has a structure, in which only a bottom surface of the container is heated, so that the structure is inevitably inefficient, so that only about 30% of heat energy supplied from the heat source is used for cooking, and the remaining heat energy of 70% is consumed while being discharged to the air.

Further, most of the cooking containers have single container structures, so that it is difficult to find a solution to solve the aforementioned problem.

In addition, in terms of loss of heat energy, the cooking container in the related art conflicts to even the government policy “low carbon and green growth”, which has been built in consideration of depletion of fossil fuel, prevention of global warming, and the like.

In addition, the large number of cooking containers under the banner of high efficiency has been released in accordance with an expansion of a leisure culture and a demand for camping containers according to the expansion of the leisure culture, but those cooking containers are not free from the aforementioned problem.

With respect to this, efforts to achieve high efficiency of energy by expanding a heat transmitting area of a cooking container are disclosed under Korean Patent Application Laid-Open Nos. 2002-0027194 and 2013-0128948, and the like. However, even though a heat transmitting area is wide, heat loss through an area around a lower part of the cooking container, of which every side is surrounded by air, is inevitable, and the disclosed patent applications simply achieve an effect that utilization of heat energy is slightly increased to attribute to decrease a cooking time, compared to the related art, so that the aforementioned patent applications cannot overcome a limit of the prior art.

As another example, an attempt to increase heat transmission efficiency by creating a container main body of a cooking container in a dual structure, in which the container main body is dualized by an internal wall body and an external wall body, and filling a space between the internal wall body and the external wall body with an operating liquid, or to improve heat reservance by forming the space as a vacuum insulating layer is disclosed in Japanese Patent Application Laid-Open Nos. H56-169825 and H63-48526, and the domestic technologies, which are further improved based on the Japanese technologies, is disclosed in Korean Patent Application Laid-Open No. 2012-0036088, and the like.

However, when the internal space of the container main body of the dual structure is filled with the operating liquid, a danger of explosion according to a large variation in pressure during a phase change is high, it is not easy to fill the operating liquid, and manufacturing costs are increased.

Further, when the internal space of the container main body of the dual structure is vacuum-insulated, heat reservance may be good by insulation, but heat transmission efficiency is rather degraded while cooking.

In addition, Korean Patent Application Laid-Open No. 2012-0036088 including improved characteristics needs to include a separate valve member, so that a structure thereof is complex, and foreign materials are caught to cause a hygienic problem and degrade cleanness when a cooking container is used for a long time, and Korean Patent Application Laid-Open No. 2012-0036088 also has a structure including a heat transmitting medium as an operating liquid. Accordingly, Korean Patent Application Laid-Open No. 2012-0036088 has improved (prevent explosion) a part of the function of Japanese Patent Application Laid-Open Nos. H56-169825, but still has the aforementioned disadvantage of Japanese Patent Application Laid-Open No. H56-169825.

Further, it is impossible to process condensate water generated on an internal surface of a lid while cooking in the structure, so that the structure has a limit in that the condensate water is dropped to food while cooking, so that the cooked food is risen or overcooked to degrade food taste.

Further, it is impossible to control smell (smell of a Kimchi stew, a fish pot stew, and the like) generated while cooking, so that a cook and a diner need to endure the smell.

### SUMMARY OF THE INVENTION

The present invention has been made in an effort to provide a high efficient hybrid eco-friendly cooking container, which utilizes at least 40% of total heat energy consumed while heating a cooking container for cooking, thereby improving cooking efficiency, efficiently removing condensate water generated while cooking, and burning even odor molecules and minimizing generation of smell.

An exemplary embodiment of the present invention provides a high efficient hybrid eco-friendly cooking container, including: a container main body configured to contain a cooked material; and a lid body configured to seal an opened upper part of the container main body, in which the container main body has a dual structure, which includes a container inner skin and a container outer skin, and in which an air chamber empty while maintaining a predetermined interval is formed between the container inner skin and the container outer skin, a plurality of exhaust holes communicated with the air chamber is formed in a circumference of an upper end part of the container outer skin, an upper end of the container inner skin and an upper end of the container outer skin are connected with a connection body, and a circumference of the upper end of the container inner skin is bent in an outer direction to form a latching jaw part and be integrated with the connection body, and an assembling recess shaped like a half-circle is formed on a lower surface of the connection body with an interval corresponding to the latching jaw part and in this state, the upper end of the container outer skin is fitted into the assembling recess, and a flow hole is formed in the latching jaw part.

The latching jaw part may be formed to be downwardly inclined in the outer direction.

A boundary protecting ring may be fastened along a circumference of the lid body, in such a manner that a lower end of the boundary protecting ring may be disposed to be in contact with the outermost side of the latching jaw part so as not to hide the flow hole.

A discharge guide may be downwardly extended at an inner side of the assembling recess, in such a manner that the discharge guide may be extended up to an upper part of the exhaust hole.

According to the present invention, the following effects may be obtained.

First, it is possible to innovatively solve heat energy waste in an inefficient current practice, in which only about 30% of heat energy is used for cooking, and heat energy of 70% or more is discharged to the air, which is a conventional method continuing for several thousands of years.

Second, it is possible to innovatively solve electric energy waste due to a problem in that most of heat generated during cooking increases a temperature of indoor air, so that efficiency of a cooler is considerably degraded for the summer season.

Third, it is possible to considerably decrease a cooking time.

Fourth, it is possible to enable anybody to cook tasty cooked rice, such as rice cooked in a mess kit used in a military unit.

Fifth, it is possible to enable anybody to rapidly cook glutinous Ramen within several minutes, which is not overcooked at all even though Ramen noodles and Ramen soup powder are simultaneously put together with cold water and cooked.

Sixth, it is possible to enable anybody to cook specially tasty frozen food, such as fish and dumpling, without a technique.

Seventh, it is possible to suppress generation of smell by burning odor molecules generated while cooking and absolutely decreasing the odor molecules.

Eighth, it is possible to naturally remove condensate water generated on an internal surface of a lid while cooking, thereby solving a problem in that condensate water is fallen onto food to degrade purity of the food.

### BRIEF DESCRIPTION OF THE DRAWINGS

FIG. 1 is a perspective view of an example of a high efficient hybrid eco-friendly cooking container according to the present invention.

FIG. 2 is a front view of the example of the high efficient hybrid eco-friendly cooking container according to the present invention.

FIGS. 3 and 4 are enlarged cross-sectional views of principal parts for describing an operation relation of the high efficient hybrid eco-friendly cooking container according to the present invention.

### DETAILED DESCRIPTION

Hereinafter, an exemplary embodiment according to the present invention will be described in more detail with reference to the accompanying drawings.

Before describing the present invention, a specific structure and functional descriptions below are simply exemplified for the purpose of describing the exemplary embodiment according to a concept of the present invention, and the exemplary embodiment according to the concept of the present invention may be implemented in various forms, and it shall not be interpreted that the exemplary embodiment according to the concept of the present invention is not limited to the exemplary embodiments described in the present specification.

Further, the exemplary embodiment according to the concept of the present invention may be variously modified and have various forms, so that specific exemplary embodiments will be illustrated in the drawings and described in detail in the present specification. However it should be understood that the invention is not limited to the specific embodiments, but includes all changes, equivalents, or alternatives which are included in the spirit and technical scope of the present invention.

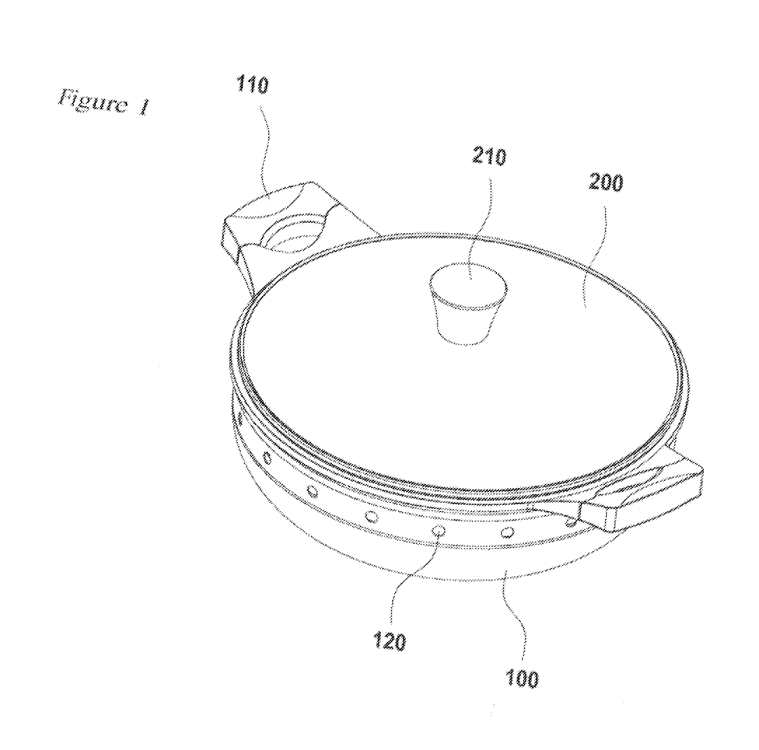

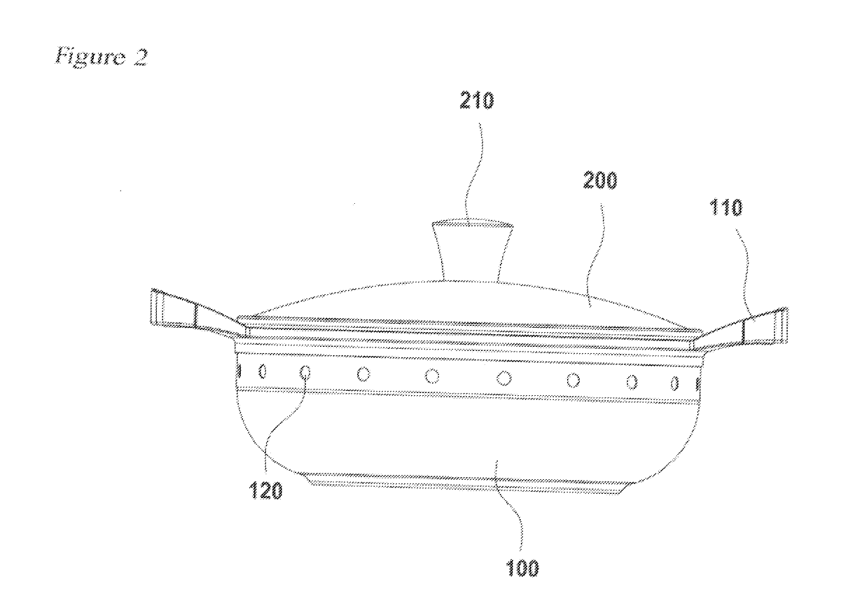

As illustrated in FIGS. 1 and 2, a cooking container according to the present invention has a shape similar to that of a general cooking container.

That is, the present invention is applicable to all of the cooking containers used as a cooking container, so that an illustrated shape is only illustrative.

Particularly, it is a matter of course that the present invention is applicable to portable pots and pans for camping, which are widely used in a recent active leisure activity and an explosively grown outdoor market.

Accordingly, an example of an illustrated shape is just an example for describing the present invention, so that the present invention does not need to be limited to the container having the suggested shape.

The cooking container according to the present invention basically includes a container main body 100 capable of containing a cooked material, and a lid body 200 for sealing an opened upper part of the container main body 100.

Further, main body handles 110 are provided at points, which are symmetric to each other based on a center of a circle, of a circumference of an outer peripheral surface of the container main body 110, and a lid knob 210 is provided at a peak of an external surface of the lid body 200.

In addition to the basic configurations, an exhaust hole 120, which is one of the distinguishing configurations of the present invention, is further provided, and a plurality of exhaust holes 120 is formed in a circumference direction of an upper part of the outer peripheral surface of the container main body 100 with a predetermined interval.

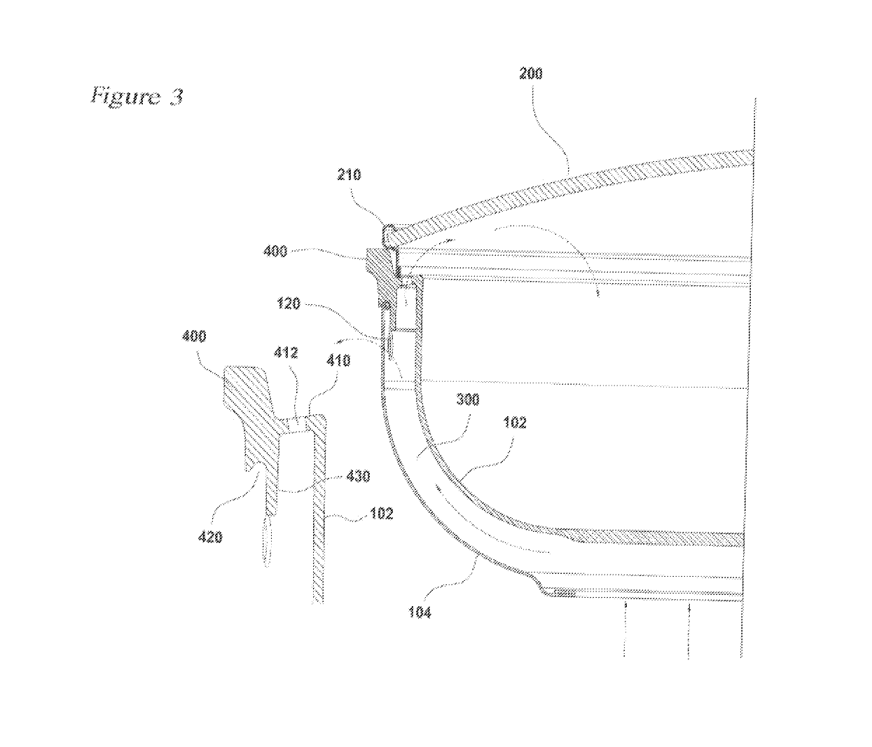

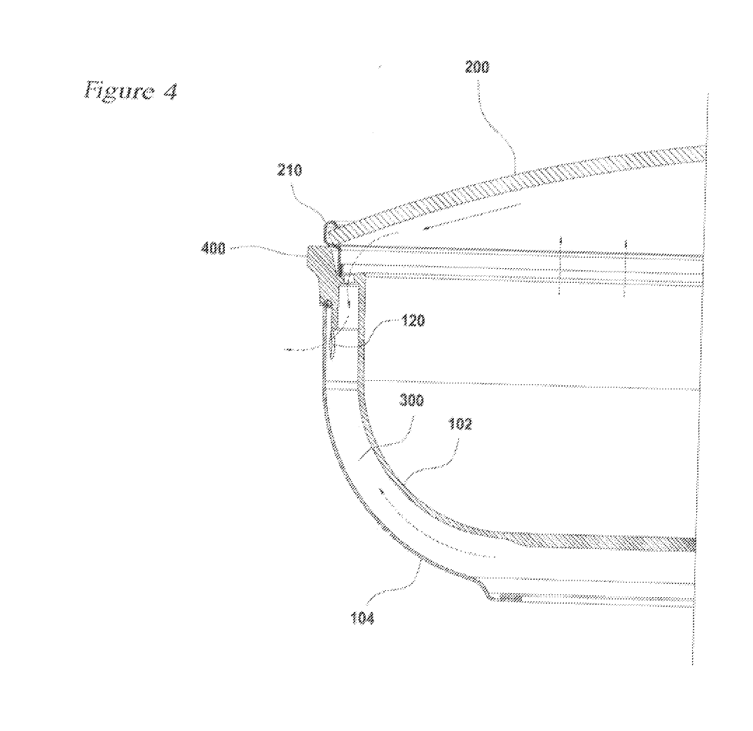

Particularly, the container main body 100 according to the present invention has a dual structure, which includes a container inner skin 102 and a container outer skin 104, and in which an air chamber 300 empty while maintaining a predetermined interval is formed between the container inner skin 102 and the container outer skin 104 as illustrated in FIGS. 3 and 4.

As a matter of course, the dual structure itself is already publicly known, but the present invention is characterized in that the air chamber 300 configuring the dual structure is maintained in an empty state unlike the related art. Accordingly, the dual structure in the related art is a structure filled with heat transfer oil and the like, so that there are many problems.

According to the present invention, the air chamber 300 is not merely empty and the exhaust holes 120 are configured to be communicated with the air chamber 300.

Accordingly, as illustrated in FIG. 3, when a bottom plate of the cooking container is heated by a heat source, a part of the heat energy generated by the heat source is used for heating and cooking food contained inside the cooking container, and a part of the heat energy is used for heating the air chamber 300, and the remaining heat energy is consumed while spreading to the air.

In this case, since the air chamber 300 is formed along the circumference of the container main body 100, the heated air inside the air chamber 300 transfers heat to the container inner skin 102 of the container main body 100 to entirely and evenly heat the container inner skin 102, so that it is possible to evenly cook the contained food, thereby uniformly maintaining taste of the cooked food regardless of a portion of the cooked food.

Accordingly, in addition to heating the bottom plate, heating a lateral part of the container is further implemented, so that it is possible to further improve utilization of heat energy compared to the related art. As a result of a test, it could be seen that the container in the related art uses only about 30% of heat energy, but the structure according to the present invention utilizes 40% of heat energy to improve utilization of heat energy.

Further, the air chamber 300 according to the present invention is communicated with the exhaust holes 120, so that heated and risen air is discharged to the outside through the exhaust holes 120, thereby preventing a danger of explosion due to internal expansion.

In the meantime, an upper end of the container inner skin 102 and an upper end of the container outer skin 104 are connected with a connection body 400, and the connected connection body 400 is a means for supporting the lid body 200.

In this case, the connection of the container inner skin 102 and the connection body 400 is configured in such a manner that a circumference of the upper end of the container inner skin 102 is bent in an outer direction and is downwardly extended in a bent state to form a latching jaw part 410, and the container inner skin 102 is integrated with the connection body 400.

Particularly, the latching jaw part 410 needs to be formed to be downwardly inclined toward the outside for the purpose of inducing a smooth flow of an internal pressure when the internal pressure of the cooking container is changed while heating, and making condensate water generated on an internal surface of the lid body 200 smoothly flow down and be collected, and be easily discharged, which is a distinguishing structure of the present invention, and is not disclosed in any related art.

Further, a flow hole 412 passes through the latching jaw part 410.

In this case, the flow hole 412 is used as a rise path of the air heated by the air chamber 300 and a path for discharging the condensate water formed on the internal surface of the lid body 200.

Further, an assembling recess 420 shaped like a half-circle and a discharge guide 430 downwardly extended from an inner side of the assembling recess 420 are provided on a lower surface of the connection body 400 with an interval corresponding to the latching jaw part 410.

In this case, the assembling recess 420 is a part, into which the upper end of the container outer skin 104 is fitted to induce sealing, and the upper end of the container outer skin 104 is bent in a circular shape toward an inner side of the cooking container in order to improve sealing performance, and has a curvature corresponding to the half-circular assembling recess 420, so that it is possible to maintain close coupling and excellent sealing performance. However, in the present invention, sealing performance between the assembling recess 420 and the container outer skin 104 is not an important factor (because there are the exhaust holes), but it is necessary to improve hygienic performance and cleaning convenience by preventing foreign materials from being fixed due to steam.

To this end, the discharge guide 430 extended from a part of the assembling recess 420 in a down direction is further provided. In this case, the discharge guide 430 needs to be essentially extended up to the upper part of the exhaust hole 120, and air containing moisture flowing in an upper layer while an internal pressure is increased is guided up to the exhaust holes 120 and then immediately discharged to the outside, so that it is possible to prevent moisture and the like from moving toward the assembling hole 420, being attached, and being fixed, thereby preventing hygienic performance from being degraded.

Further, the lid body 200 is a means for sealing the opened upper part of the container main body 100 and covering the container main body 100 so that a cooked material is cooked, and a boundary protecting ring 210 is fastened along a circumference of the lid body 200.

A lower end of the boundary protecting ring 210 is seated on an upper end surface of the connection body 400 to be sealed, and a lower end of the boundary protecting ring 210 needs to be essentially disposed so as not to hide the outermost side of the latching jaw part 410, that is, the flow hole 412.

That is, the lower end of the boundary protecting ring 210 needs to be positioned so that the flow hole 412 is communicated with the air chamber 300 and the inner side of the cooking container.

The present invention including the aforementioned configuration has an operation relation described below.

As illustrated in FIG. 3, a part of heat is transferred into the container while the bottom surface of the container main body 100 is heated, so that a cooked material is heated, and a part of the heat moves into the air chamber 300.

In this case, the heat moving to the air chamber 300 entirely and evenly heats the container main body 100 while being spread along a circumferential surface of the container main body 100.

Particularly, a part of heated air inside the air chamber is discharged through the exhaust holes 120, and the remaining part of the heated air moves inside the container, that is, a lower surface of the lid body 200, through the flow holes 412, and then moves to an upper part of the contained food to heat the upper part of the food.

Accordingly, the cooked material is heated and cooked from all of the sides including a bottom, a lateral side, and an upper side, so that it is possible to rapidly cook, uniformly cook, and decrease a cooking time, thereby decreasing the amount of nutrients damaged by heat and improving taste of the food.

That is, according to the present invention, it is possible to cook food by a triple heating method.

In the meantime, as illustrated in FIG. 4, flowing air ascending by a change in an internal pressure during cooking hits a lower surface of the lid body 200, descends along the lower surface of the lid body 200, moves to the upper side of the air chamber 300 through the flow hole 412, and then is discharged to the outside through the exhaust holes 120.

During the process, a part of smell generated during cooking is decomposed by the considerable amount while being in contact with the heated air, which is heated with high-temperature heat within the air chamber 300, so that generation of the smell is considerably decreased.

Particularly, condensate water generated on the lower surface of the lid body 200 flows down along the lid body 200, moves toward the air chamber 300 through the flow hole 412, is evaporated while being in contact with the heated air, and then is discharged to the outside through the exhaust holes 120.

As described above, the cooking container according to the present invention has many advantages in that it is possible to solve a problem, such as water falling contamination by condensate water and generation of smell, there is no danger of explosion, and it is possible to decrease a cooking time, and evenly and rapidly heat and cook an entire cooked material.

What is claimed is:

1. A high efficient hybrid eco-friendly cooking container, comprising:
a container main body configured to contain a cooked material; and
a lid body configured to seal an opened upper part of the container main body,
wherein the container main body has a dual structure, which includes a container inner skin and a container outer skin, and in which an air chamber empty while maintaining a predetermined interval is formed between the container inner skin and the container outer skin,
a plurality of exhaust holes communicated with the air chamber is formed in a circumference of an upper end part of the container outer skin,
an upper end of the container inner skin and an upper end of the container outer skin are connected with a connection body, and a circumference of the upper end of the container inner skin is bent in an outer direction to form a latching jaw part and be integrated with the connection body, and an assembling recess shaped like a half-circle is formed on a lower surface of the connection body with an interval corresponding to the latching jaw part and in this state, the upper end of the container outer skin is fitted into the assembling recess, and
a flow hole is formed in the latching jaw part.

2. The high efficient hybrid eco-friendly cooking container of claim 1, wherein the latching jaw part is formed to be downwardly inclined in the outer direction.

3. The high efficient hybrid eco-friendly cooking container of claim 1, wherein a boundary protecting ring is fastened along a circumference of the lid body, in such a manner that a lower end of the boundary protecting ring is disposed to be in contact with the outermost side of the latching jaw part so as not to hide the flow hole.

4. The high efficient hybrid eco-friendly cooking container of claim 1, wherein a discharge guide is downwardly extended at an inner side of the assembling recess, in such a manner that the discharge guide is extended up to an upper part of the exhaust hole.
